(19) United States
(12) Patent Application Publication
(10) Pub. No.: US 2023/0233943 A1
(43) Pub. Date: Jul. 27, 2023

(54) METHOD AND SYSTEM FOR PROCESSING TEXTUAL DEPICTIONS IN A COMPUTER GAME SCREENSHOT

(71) Applicant: PEPPER ESPORTS INC., Vancover (CA)

(72) Inventor: Gabriel Antunes de Melo GARCIA, Vancouver (CA)

(21) Appl. No.: 17/768,192

(22) PCT Filed: Oct. 7, 2020
(86) PCT No.: PCT/IB2020/059429

§ 371 Date: Apr. 11, 2022

Related U.S. Application Data
(60) Provisional application No. 62/914,406, filed on Oct. 11, 2019.

(51) Int. Cl. A63F 13/655; G06V 30/148

(52) U.S. Cl. CPC A63F 13/655; G06V 30/153

(57) ABSTRACT

Methods, systems, and techniques for processing textual depictions in a computer game screenshot. At least one processor is used to obtain a screenshot of a computer-implemented game, wherein the screenshot includes a game data region. The game data region includes a textual depiction indicative of how a user performed in the game. The at least one processor segments the textual depiction from the screenshot by performing image segmentation on the screenshot and determines alphanumeric characters corresponding to the textual depiction. After determining the alphanumeric characters, the at least one processor outputs the characters to, for example, storage or a display. Image processing in the form of any one or more of aspect ratio transformation, cropping, scaling, binarizing, and blurring may be done prior to segmentation.

### FIELD

The present disclosure is directed at methods, systems, and techniques for processing textual depictions in a computer game screenshot.

### BACKGROUND

Computer gaming, including competitive computer gaming in the form of “e-sports”, is becoming increasingly popular. The nature of competition requires that different players' results be compared to each other.

### SUMMARY

According to a first aspect, there is provided a method comprising using at least one processor to: obtain a screenshot of a computer-implemented game, wherein the screenshot comprises a game data region, the game data region comprising a textual depiction indicative of how a user performed in the game; segment the textual depiction from the screenshot by performing image segmentation on the screenshot; determine alphanumeric characters corresponding to the textual depiction; and after determining the alphanumeric characters, output the alphanumeric characters.

Using the at least one processor to output the alphanumeric characters may comprise using the at least one processor to store the alphanumeric characters.

The method may further comprise prior to using the at least one processor to segment the textual depiction, using the at least one processor to transform the aspect ratio of the screenshot from an initial aspect ratio to a game-customized aspect ratio.

The method may further comprise prior to using the at least one processor to segment the textual depiction, using the at least one processor to crop the screenshot according to game-customized crop parameters to isolate the game data region of the screenshot from a remainder of the screenshot.

The method may further comprise prior to using the at least one processor to segment the textual depiction, using the at least one processor to scale the game data region of the screenshot larger according to game-customized scaling parameters.

The method may further comprise prior to using the at least one processor to segment the textual depiction, binarizing and then blurring the binarized game data region according to game-customized binarization parameters and game-customized blurring parameters, respectively.

The method may further comprise after segmenting the textual depiction, using the at least one processor to determine alphanumeric characters corresponding to the textual depiction.

Using the at least one processor to determine alphanumeric characters corresponding to the textual depiction may comprise comparing the textual depiction to game-customized font characters.

The method may further comprise after determining the alphanumeric characters, using the at least one processor to process the alphanumeric characters using a regular expression to identify particular user statistics.

Using the at least one processor to obtain the screenshot may comprise obtaining the screenshot from at least one additional processor networked to the at least one processor, wherein the at least one additional processor retrieves and queues a collection of screenshots of which the screenshot is one for batch transmission to the at least one processor.

According to another aspect, there is provided a system comprising: at least one processor; a communications interface communicatively coupled to the at least one processor; a non-transitory computer readable medium communicatively coupled to the processor, wherein the medium has stored thereon computer program code that is executable by the at least one processor and that, when executed by the at least one processor, causes the at least one processor to perform the method of any of the foregoing aspects or suitable combinations thereof.

A non-transitory computer readable medium having stored thereon computer program code executable by at least one processor and that, when executed by the at least one processor, causes the at least one processor to perform the method of any of the foregoing aspects or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Reference will now be made, by way of example only, to the accompanying drawings in which:

FIG. 1 is a system for processing textual depictions in a computer game screenshot, according to an example embodiment;

FIG. 2 is a method for processing textual depictions in a computer game screenshot, according to another example embodiment;

FIG. 3A depicts image processing done to process textual depictions in a computer game screenshot, according to another example embodiment;

FIG. 3B depicts further image processing done to process textual depictions in a computer game screenshot, according to the example of FIG. 3A;

FIG. 3C depicts further image processing done to process textual depictions in a computer game screenshot, according to the example of FIG. 3B;

FIG. 3D depicts image processing done to process textual depictions in a computer game screenshot, according to the example of FIG. 3C;

FIG. 3E depicts an output of image segmentation performed on FIG. 3D;

FIG. 4 is a method for performing pre-segmentation image processing on a screenshot, according to another example embodiment;

FIG. 5 depicts a computer system in the form of a personal computer or server that may be used in any one or more of the embodiments of FIGS. 1-4, or in another example embodiment; and

FIG. 6 depicts a computer system in the form of a mobile device that may be used in any one or more of the embodiments of FIGS. 1-4, or in another example embodiment.

### DETAILED DESCRIPTION

In competitive gaming, different players of a game (hereinafter referred to as that game's “users”) compete against each other. For example, users of a game may play respective instances of that game at their own computers. At the conclusion of a round of play, the users may wish to compare game statistics such as their scores against each other to determine their relative ranking. This is often done manually, even in a professional setting. Alternatively, a user may use a program installed on his/her computer to automatically collect those statistics. The program may take the form of injecting a dynamic link library (“DLL”) into the game's loading chain.

A technical problem resulting from injecting a DLL in the game's loading chain is that is the same technique often used by software that a user may use to cheat during the game (e.g., to obtain unlimited ammo or life) (“cheating software”). In order to combat cheating software, game providers may use “anti-cheating software” that monitors the user's computer for this type of DLL injection. When detected, the user may be kicked out of the game and/or prohibited from using the game in the future, regardless of whether the DLL injection resulted from cheating software or from a legitimate attempt by the user to collect his/her game statistics.

In at least some example embodiments herein, game statistics are collected not through DLL injection but instead through processing textual depictions that the game displays. The textual depictions comprise game statistics that may vary with the game; example statistics may comprise score, deaths, kills, time survived in game, rank, number of allies revived, and number of allies respawned. A screenshot of the game depicting the textual depiction is captured, following which image segmentation is used to extract the textual depiction from the processed screenshot. The alphanumeric characters that correspond to the textual depiction are determined and output. The characters may be output, for example, to storage. Capturing game statistics in this manner overcomes the problem of a user being mischaracterized as employing cheating software as a result of DLL injection. Rather, DLL injection, which also poses security risks, can be avoided entirely.

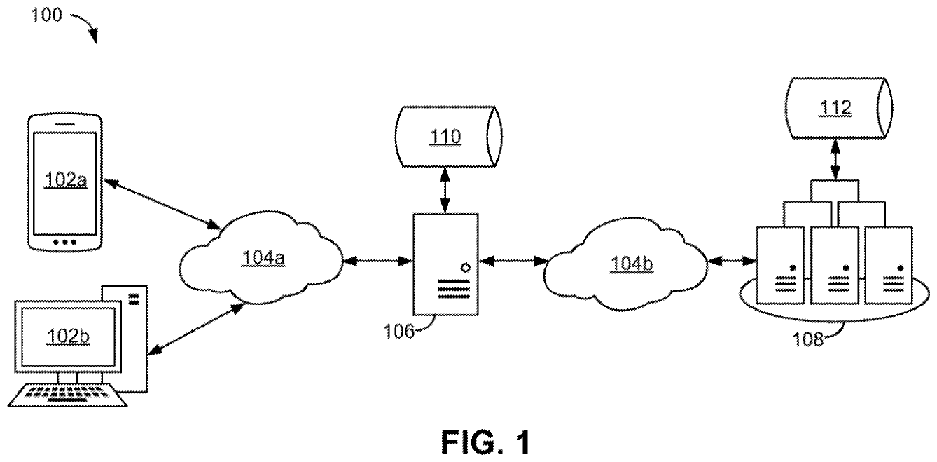

Referring now to FIG. 1, there is shown a system 100 for processing textual depictions in a computer game screenshot, according to an example embodiment. The system 100 comprises a first user computer 102a in the form of a mobile device such as a mobile phone or tablet and a second user computer 102b in the form of a desktop personal computer. The user computers 102a,b run the computer-implemented game. The user computers 102a,b are networked to a backend server 106 via a first network 104a. The backend server 106 is communicatively coupled to a backend server database 110 and is networked to a number of servers 108 via a second network 104b. The servers 108 are connected to each other in parallel and are configured to perform parallel computing, and they are communicatively coupled to and share a servers database 112.

Each of the user computers 102a,b, the backend server 106, and the servers 108 comprises at least one processor communicatively coupled to at least one non-transitory computer readable medium, with the non-transitory computer readable medium having stored on it computer program code that, when executed by the at least one processor, causes the at least one processor to perform certain functionality as described herein.

The first network 104a may comprise, for example, a local area network (“LAN”) and the second network 104b may comprise, for example, a wide area network (“WAN”) such as the Internet. This configuration may be used when the backend server 106 is located on-premises and the servers 108 are located at an off-site data center. More generally, the first network 104a may be a LAN or a WAN and the second network 104b may also be a LAN or a WAN.

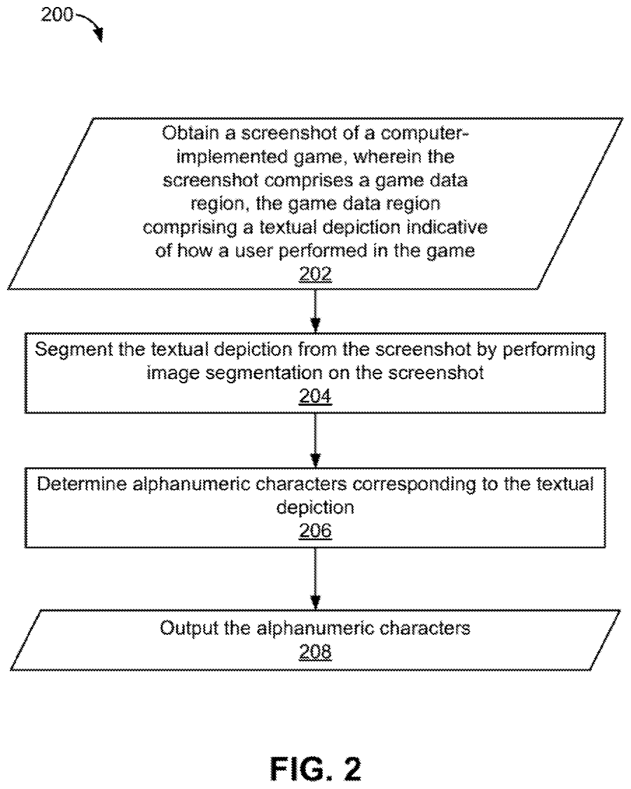

During the operation of the system 100, the user computers 102a,b capture screenshots of the game running on them and send the screenshots to the backend server 106. The backend server 106 queues the screenshots and, in at least some example embodiments, stores the screenshots in the backend server database 110. From time-to-time, the servers 108 request any screenshots pending in the backend server's 106 queue. The backend server 106 replies by sending the pending screenshots to the servers 108 in a batch. The servers 108 then process the screenshots as described further in respect of FIG. 2, below, and replies to the backend server 108 with specific user game statistics. The backend server 108 may store those statistics in the backend server database 110 and/or forward those statistics to the user computers 102a,b.

While in FIG. 1 the servers 108 perform processing in parallel, in at least some different example embodiments (not depicted) the servers 108 may be replaced with a single server or with multiple servers that are not configured for parallel computing. Additionally, while in FIG. 1 the backend server 106 queues screenshots captured using the user computers 102a,b for batch transmission to and processing at the servers 108, in at least some different example embodiments the system 100 may comprise different devices that operate differently. For example, a different embodiment of the system 100 may omit the backend server 106, and the user computers 102a,b may send screenshots to one or more servers that processes them without their first being batched. Alternatively, the user computers 102a,b themselves may perform the image processing that the servers 108 in FIG. 1 perform.

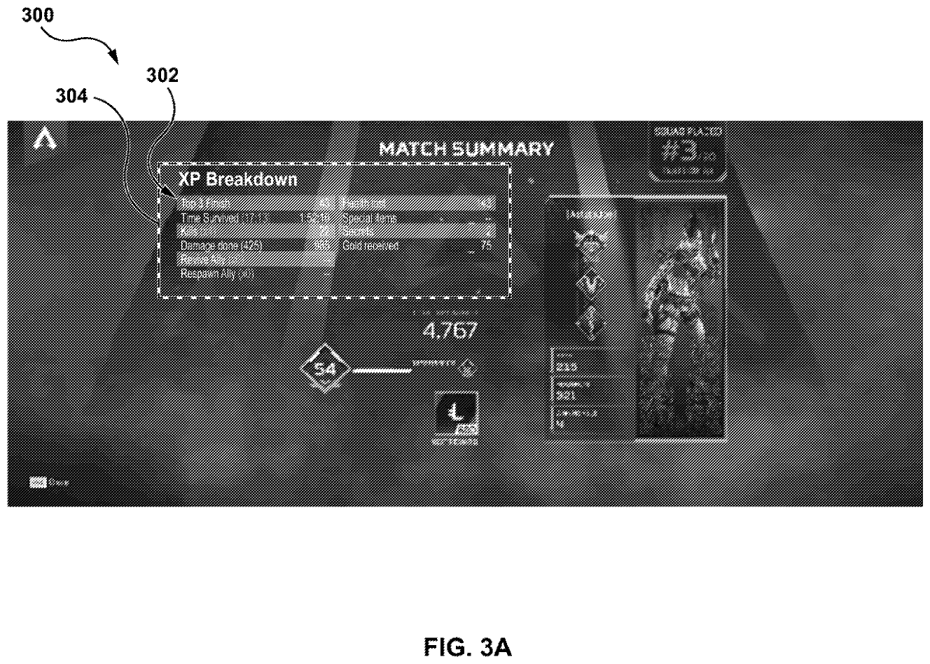

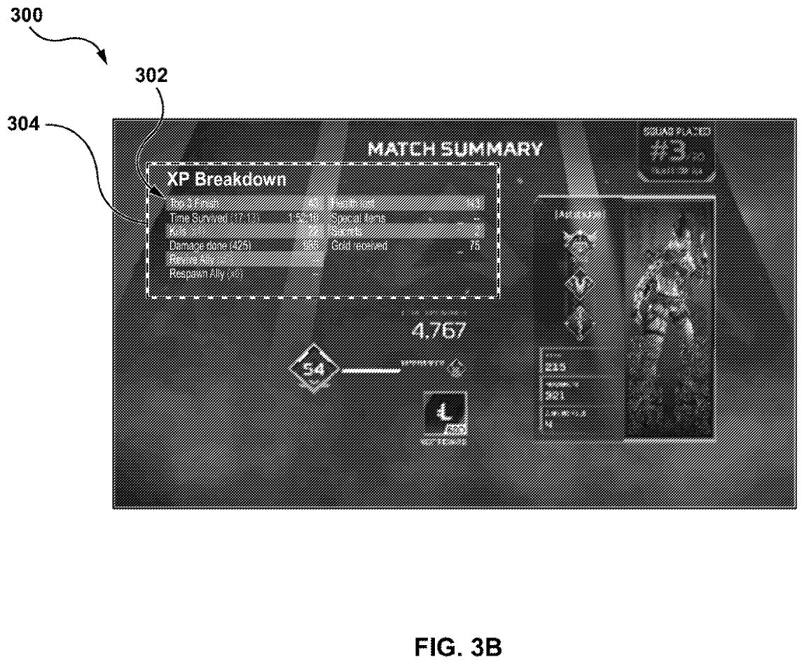

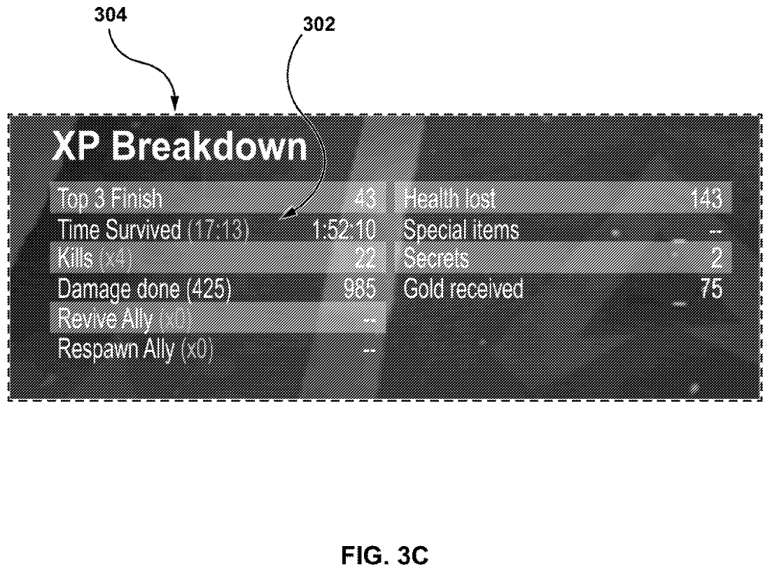

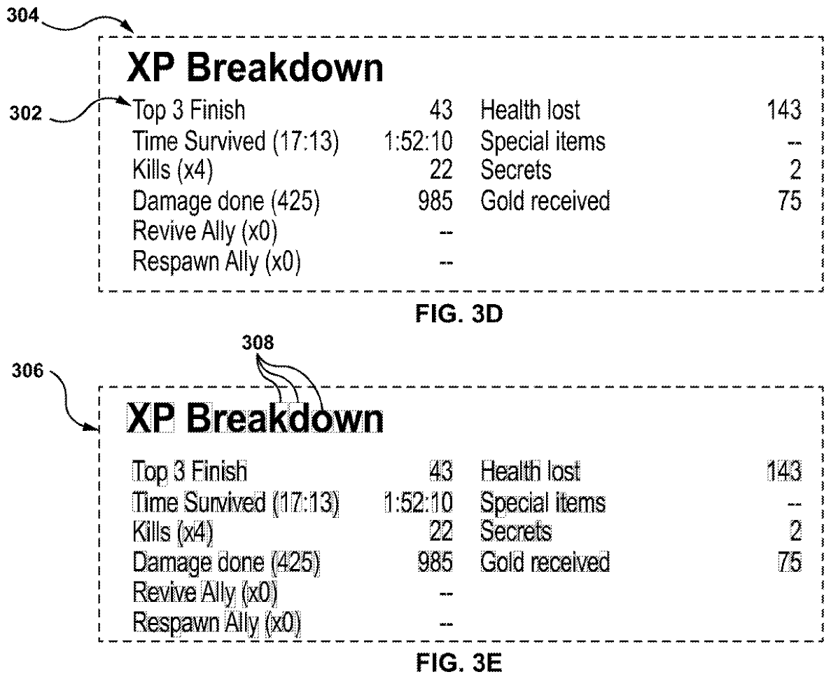

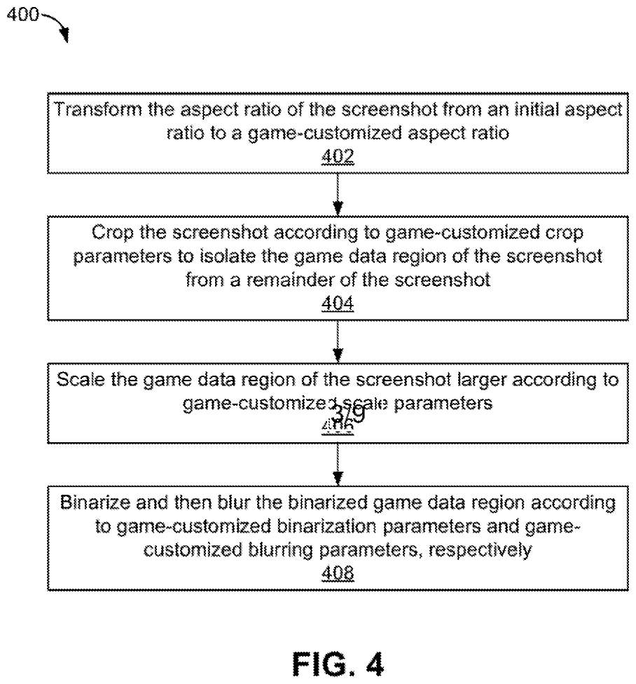

Referring now to FIG. 2, there is depicted a method 200 for processing textual depictions in a computer game screenshot, according to another example embodiment. The method 200 is expressed as computer program code and is stored in one or more non-transitory computer readable media comprising part of the servers 108. The code, when executed by at least one processor that comprises part of the servers 108, causes the at least one processor to perform the method 200. The method 200 of FIG. 2 is described below in conjunction with FIGS. 3A-3E and FIG. 4, with FIGS. 3A-3D and FIG. 4 depicting pre-segmentation image processing successively done to a screenshot 300, and FIG. 3E depicting an output of image segmentation.

The servers 108 obtain a screenshot 300 of a computer-implemented game at block 202; an example screenshot 300 is shown in FIG. 3A. The screenshot 300 comprises a game data region 304, with the game data region 304 comprising a textual depiction 302 indicative of how a user performed in the game. The textual depiction 302 is of alphanumeric characters depicting the user's game statistics. The alphanumeric characters are in image form and accordingly cannot be captured using optical character recognition technology; instead, the servers 108 segment the textual depiction 302 from the screenshot 300 by performing image segmentation on the screenshot 300 at block 204.

In order to prepare the screenshot 300 for image segmentation, the servers 108 perform various types of additional image processing on the screenshot 300 as described below and as depicted in FIG. 4. While in the presently described example embodiment all of the image processing depicted and discussed below is performed on the screenshot 300 in the order described, in at least some other example embodiments one or both of the types and order of image processing may be varied. For example, the servers 108 may perform image segmentation on the screenshot 300 immediately after receiving the screenshot 300 and without performing any of the processing outline in the method 400 described in respect of FIG. 4.

Furthermore, in at least the presently described example embodiment, the servers 108 when performing different types of image processing (including the image segmentation) do so in accordance with game-customized parameters that are empirically selected to correspond to specific games (“game-customized parameters”). These parameters may be stored in the servers database 112 and retrieved as necessary by the servers 108. Game-customized parameters may be unique to a particular game; conversely, they may be shared between multiple games if those games share suitable characteristics. In different example embodiments, generic and non-customized parameters may be applied during image processing. In addition to the game-customized parameters being empirically selected for certain games, the methods applied during image processing described below may be analogously empirically selected.

After capturing the screenshot 300, the servers 108 transform the aspect ratio of the screenshot 300 from an initial aspect ratio to a game-customized aspect ratio at block 402. In the presently described example embodiment, the game-customized aspect ratio is 16:9 and the aspect ratio transformation is performed without losing or altering any of the textual depiction 302. FIG. 3B depicts the screenshot 300 of FIG. 3A after its aspect ratio is transformed at block 402.

Following block 402, at block 404 the servers 108 crop the screenshot 300 according to game-customized crop parameters to isolate the game data region 304 of the screenshot 300 from a remainder of the screenshot 300. In the presently described example embodiment, the game-customized crop parameters comprise the (x,y) coordinates defining the perimeter of the game data region 304. In at least some different example embodiments, the game-customized crop parameters may comprise a single (x,y) coordinate defining one location on the game data region's 302 perimeter (e.g., the top left corner) and offsets from that location defining the remainder of the area to be cropped.

Following block 404, at block 406 the servers 108 scale the textual depiction 302 of the game data region of the screenshot 300 larger according to game-customized scaling parameters. In at least the presently described example embodiment, the scaling method used is bicubic interpolation, and the game-customized scaling parameters comprise a 4×4 neighborhood and a scale factor of 3. More generally, the game-customized scaling parameters may differ, taking into account game resolution. In at least some different example embodiments, the game-customized scaling parameters may comprise the scaling method itself, thereby permitting different scaling methods to be used on screenshots 300 from different games. FIG. 3C depicts the game data region 304 after the remainder of the screenshot 300 has been cropped away and scaled. Example alternatives to bicubic interpolation for scaling comprise bilinear interpolation, nearest-neighbor interpolation, and/or Lanczos interpolation.

Following block 406, at block 408 the servers 108 binarize and then blur the binarized game data region 304 according to game-customized binarization parameters and game-customized blurring parameters, respectively. In at least the presently described embodiment, the binarization is performed by thresholding and the blurring is performed by applying a Gaussian blur with a kernel having a base size of 11×11 (an example game-customized blurring parameter) and that scales with image size. The game-customized binarization parameters comprise a numeric threshold; for example, when the numeric threshold is an intensity threshold, pixels having an intensity greater than this threshold are binarized to one of black and white, and pixels having an intensity less than this threshold are binarized to the other of black and white. When the image being binarized is greyscale, a single numeric threshold may be used; when the image being binarized has color components, the intensity of each of the color components may be compared to a threshold for that component to determine intermediate results, and the intermediate results may be combined (e.g., by ANDing or ORing them together) to determine the final binarization result. The game-customized blurring parameters may more generally depend on the final resolution of the game data region 304 after scaling. The thresholding may be done with or without taking into account range or variance of neighboring pixels. As discussed above for scaling, more generally the game-customized binarization and blurring parameters may respectively comprise the binarization and blurring methods themselves. FIG. 3D depicts the game data region 304 after binarizing and blurring. Example alternatives to applying a Gaussian blur for blurring comprise applying a normalized box filter, a median filter, and/or a bilateral filter.

Following block 408 and returning to the method 200, at block 204 the servers 108 segment the textual depiction 302 from the screenshot 300 depicted in FIG. 3D by performing image segmentation on the screenshot 300. In the presently described example embodiment, the servers 108 apply a contour finding method in order to perform image segmentation. Example methods comprise that described in Satoshi Suzuki and Keiichi Abe, “Topological structural analysis of digitized binary images by border following,” Computer Vision, Graphics, and Image Processing, Vol. 30, No. 1, April 1985, pp. 32-46; and Cho-huak The and Roland T. Chin, “On the Detection of Dominant Points on Digital Curves,” IEEE Transactions on Pattern Analysis and Machine Intelligence, Vol. 2, No. 8, August 1989, pp. 859-872, the entireties of both of which are hereby incorporated by reference herein. The result of the image segmentation is shown in FIG. 3E, with boxes 308 segmenting each alphanumeric character in preparation for processing at block 208.

After segmenting the textual depiction 302, the servers 108 at block 208 determine alphanumeric characters corresponding to the segmented textual depiction 306. In the presently described example embodiment, the servers 108 use an estimator to compare the segmented textual depiction 306 to the font in which the segmented text is displayed in order to determine the alphanumeric characters. The servers 108 obtain the font from the servers database 112, which stores game-customized font characters. The estimator 108 applies least mean square error in order to minimize the error between the game-customized font characters and the textual depiction 302, with those characters resulting in minimum error being determined as the alphanumeric characters. The determined alphanumeric characters are output; for example, the servers 108 may return the determined alphanumeric characters to the backend server 106, may write them to storage such as the servers database 112, and/or return them to the user computers 102a,b for display. In at least some different example embodiments, alternatives to least mean square error may be applied; for example, the servers 108 may apply machine learning such as in the form of neural networks to determine the alphanumeric characters.

Once the servers 108 have obtained the alphanumeric characters, they may be further processed. For example, in at least the presently described embodiment the servers 108 use a regular expression to identify user statistics. The regular expression identifies certain text strings (e.g., “kills [ . . . ] 4”) that identify the statistic and its value. The statistics can then be stored and/or compared to comparable statistics belonging to other users to facilitate competition.

The embodiments have been described above with reference to flowcharts and block diagrams of methods, apparatuses, systems, and computer program products. In this regard, the flowcharts and block diagrams referenced herein illustrate the architecture, functionality, and operation of possible implementations of various embodiments. For instance, each block of the flowcharts and block diagrams may represent a module, segment, or portion of code, which comprises one or more executable instructions for implementing the specified logical function(s). In some alternative embodiments, the functions noted in that block may occur out of the order noted in those figures. For example, two blocks shown in succession may, in some embodiments, be executed substantially concurrently, or the blocks may sometimes be executed in the reverse order, depending upon the functionality involved. Some specific examples of the foregoing have been noted above but those noted examples are not necessarily the only examples. Each block of the block diagrams and flowcharts, and combinations of those blocks, may be implemented by special purpose hardware-based systems that perform the specified functions or acts, or combinations of special purpose hardware and computer instructions.

Each block of the flowcharts and block diagrams and combinations thereof can be implemented by computer program instructions in the form of computer program code. References to a “processor” herein may be to a processor of a general purpose computer, special purpose computer, or other programmable data processing apparatus to produce a machine, such that the instructions, which execute via the processor of the computer or other programmable data processing apparatus, create means for implementing the functions or acts specified in the blocks of the flowcharts and block diagrams.

These computer program instructions may also be stored in a computer readable medium that can direct a computer, other programmable data processing apparatus, or other devices to function in a particular manner, such that the instructions stored in the computer readable medium produce an article of manufacture including instructions that implement the function or act specified in the blocks of the flowcharts and block diagrams. The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions or acts specified in the blocks of the flowcharts and block diagrams.

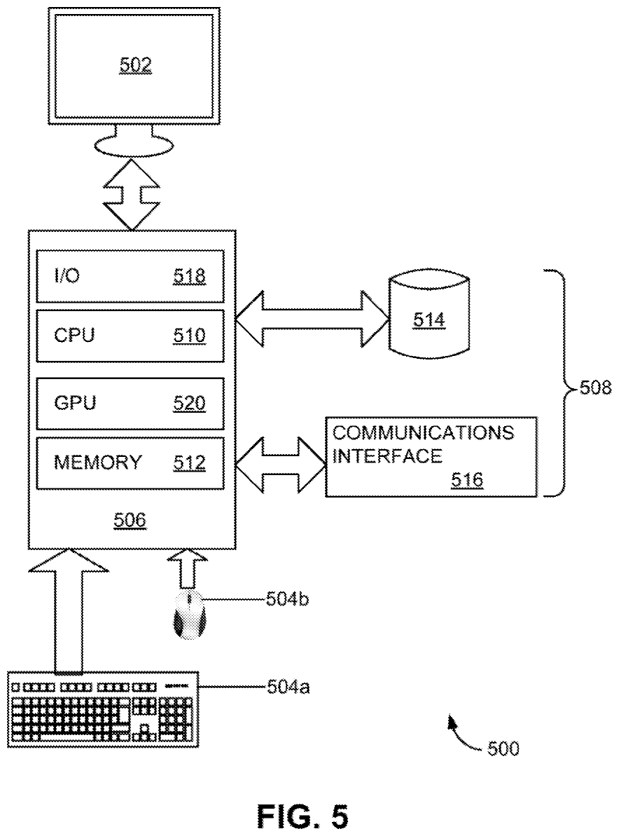

An illustrative computer system 500 that may serve as any one or more of the user computers 102a,b, the backend server 106, or one of the servers 108 is presented as a block diagram in FIG. 5. The computer system 500 comprises a display 502, input devices in the form of keyboard 504a and pointing device 504b, computer 506, and external devices 508. While the pointing device 504b is depicted as a mouse, other types of pointing devices may also be used. In at least some other embodiments, the computer system 500 may not comprise all the components depicted in FIG. 5. For example, when used as the backend server 106 and/or one of the servers 108, the computer system 500 may lack the display 502, keyboard 504a, and mouse 504b.

The computer 506 may comprise one or more processors or microprocessors, such as a central processing unit (CPU) 510, which is depicted. The CPU 510 performs arithmetic calculations and control functions to execute software stored in an internal memory 512, such as one or both of random access memory (RAM) and read only memory (ROM), and possibly additional storage 514. The additional storage 514 may comprise, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional storage 514 may be physically internal to the computer 506, or external as shown in FIG. 5, or both.

The computer system 500 may also comprise other similar means for allowing computer programs or other instructions to be loaded. Such means can comprise, for example, a communications interface 516 that allows software and data to be transferred between the computer system 500 and external systems and networks. Examples of the communications interface 516 comprise a modem, a network interface such as an Ethernet card, a wireless communication interface, or a serial or parallel communications port. Software and data transferred via the communications interface 516 are in the form of signals which can be electronic, acoustic, electromagnetic, optical, or other signals capable of being received by the communications interface 516. Multiple interfaces, of course, can be provided on the computer system 500.

Input to and output from the computer 506 is administered by the input/output (I/O) interface 518. The I/O interface 518 administers control of the display 502, keyboard 504a, external devices 508 and other analogous components of the computer system 500. The computer 506 also comprises a graphical processing unit (GPU) 520. The GPU 520 may also be used for computational purposes as an adjunct to, or instead of, the CPU 510, for mathematical calculations. However, as mentioned above, in alternative embodiments (not depicted) the computer system 500 need not comprise all of these elements. For example, the backend server 106 and/or servers 108 may lack the display 502, keyboard 504a, mouse 504b, and GPU 520.

The various components of the computer system 500 are coupled to one another either directly or indirectly by shared coupling to one or more suitable buses.

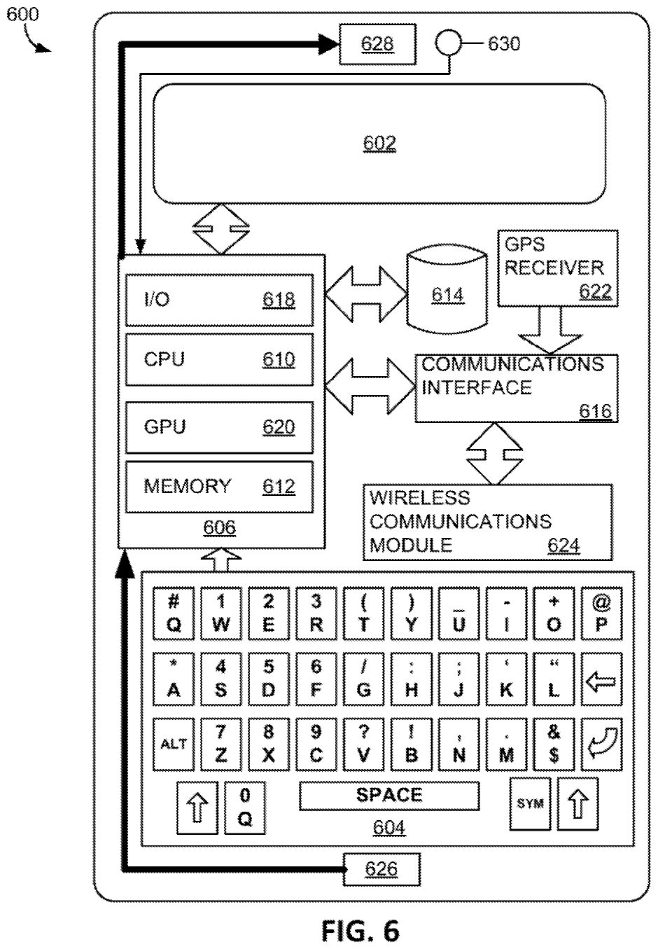

FIG. 6 shows an example networked mobile wireless telecommunication computing device in the form of the smartphone 600. The smartphone 600 may, for example, be used as the first user computer 102a. The smartphone 600 comprises a display 602, an input device in the form of keyboard 604, and an onboard computer system 606. The display 602 may be a touchscreen display and thereby serve as an additional input device, or as an alternative to the keyboard 604. The onboard computer system 606 comprises a CPU 610 having one or more processors or microprocessors for performing arithmetic calculations and control functions to execute software stored in an internal memory 612, such as one or both of RAM and ROM, is coupled to additional storage 614 that typically comprises flash memory, which may be integrated into the smartphone 600 or may comprise a removable flash card, or both. The smartphone 600 also comprises wireless communication circuitry that allows software and data to be transferred between the smartphone 600 and external systems and networks. In the example embodiment of FIG. 6, the wireless communication circuitry comprises one or more wireless communication modules 624 communicatively coupled to a communications interface 616, which for example comprises a wireless radio for connecting to one or more of a cellular network, a wireless digital network, and a WiFi™ network. The communications interface 616 also enables a wired connection of the smartphone 600 to an external computer system. A microphone 626 and speaker 628 are coupled to the onboard computer system 606 to support the telephone functions managed by the onboard computer system 606, and GPS receiver hardware 622 may also be coupled to the communications interface 616 to support navigation operations by the onboard computer system 606. The smartphone 600 also comprises a camera 630 communicative with the onboard computer system 606 for taking photos using the smartphone 600. Input to and output from the onboard computer system 1006 is administered by an input/output (I/O) interface 618, which administers control of the display 602, keyboard 604, microphone 626, speaker 628, and camera 630. The onboard computer system 606 may also comprise a separate GPU 620. The various components are coupled to one another either directly or by shared coupling to one or more suitable buses.

The term “computer system”, as used herein, is not limited to any particular type of computer system and encompasses servers, desktop computers, laptop computers, networked mobile wireless telecommunication computing devices such as smartphones, tablet computers, as well as other types of computer systems.

As will be appreciated by one skilled in the art, embodiments of the technology described herein may be embodied as a system, method, or computer program product. Accordingly, these embodiments may take the form of an entirely hardware embodiment, an entirely software embodiment (including firmware, resident software, micro-code, etc.) or an embodiment combining software and hardware that may all generally be referred to herein as a “circuit,” “module,” or “system.” Furthermore, embodiments of the presently described technology may take the form of a computer program product embodied in one or more non-transitory computer readable media having stored or encoded thereon computer readable program code.

Where aspects of the technology described herein are implemented as a computer program product, any combination of one or more computer readable media may be utilized. An example non-transitory computer readable medium may comprise, for example, an electronic, magnetic, optical, electromagnetic, infrared, or semiconductor system, apparatus, or device, or any suitable combination thereof. Additional examples of non-transitory computer readable media comprise a portable computer diskette, a hard disk, RAM, ROM, an erasable programmable read-only memory (EPROM or flash memory), a portable compact disc read-only memory (CD-ROM), an optical storage device, a magnetic storage device, or any suitable combination thereof. As used herein, a non-transitory computer readable medium may comprise any tangible medium that can contain, store, or have encoded thereon a program for use by or in connection with an instruction execution system, apparatus, or device. Thus, computer readable program code for implementing aspects of the embodiments described herein may be contained, stored, or encoded on the memory 612 of the onboard computer system 606 of the smartphone 600 or the memory 512 of the computer 506, or on a computer readable medium external to the onboard computer system 606 of the smartphone 600 or the computer 506, or on any combination thereof; the onboard computer system 606 or computer 506 may thereby be configured to perform those embodiments.

Program code embodied on a computer readable medium may be transmitted using any appropriate medium, including but not limited to wireless, wireline, optical fiber cable, radiofrequency, and the like, or any suitable combination thereof. Computer program code for carrying out operations comprising part of the embodiments described herein may be written in any combination of one or more programming languages, including an object oriented programming language and procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (e.g., through the Internet using an Internet Service Provider).

The terminology used herein is for the purpose of describing particular embodiments only and is not intended to be limiting. Accordingly, as used herein, the singular forms “a”, “an” and “the” are intended to include the plural forms as well, unless the context clearly indicates otherwise. It will be further understood that the terms “comprises” and “comprising,” when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “and/or” as used herein in conjunction with a list of items means any one or more of that list of items; for example, “A, B, and/or C” means “any one or more of A, B, and C”.

It is contemplated that any part of any aspect or embodiment discussed in this specification can be implemented or combined with any part of any other aspect or embodiment discussed in this specification.

One or more currently example embodiments have been described by way of illustration only. This description is been presented for purposes of illustration and description, but is not intended to be exhaustive or limited to the form disclosed. Many modifications and variations will be apparent to those of ordinary skill in the art without departing from the scope of the claims. It will be apparent to persons skilled in the art that a number of variations and modifications can be made without departing from the scope of the claims. In construing the claims, it is to be understood that the use of a computer to implement the embodiments described herein is essential at least where the presence or use of computer equipment is positively recited in the claims.

What is claimed is:

1. A method comprising using a processor to:
obtain a screenshot of a computer-implemented game, wherein the screenshot comprises a game data region, the game data region comprising a textual depiction indicative of how a user performed in the game;
segment the textual depiction from the screenshot by performing image segmentation on the screenshot;
determine alphanumeric characters corresponding to the textual depiction; and
after determining the alphanumeric characters, output the alphanumeric characters.

2. The method of claim 1, wherein using the processor to output the alphanumeric characters comprises using the processor to store the alphanumeric characters.

3. The method of claim 1 or 2, further comprising prior to using the processor to segment the textual depiction, using the processor to transform an aspect ratio of the screenshot from an initial aspect ratio to a game-customized aspect ratio.

4. The method of any one of claims 1 to 3, further comprising prior to using the processor to segment the textual depiction, using the processor to crop the screenshot according to game-customized crop parameters to isolate the game data region of the screenshot from a remainder of the screenshot.

5. The method of any one of claims 1 to 4, further comprising prior to using the processor to segment the textual depiction, using the processor to scale the game data region of the screenshot larger according to game-customized scaling parameters.

6. The method of any one of claims 1 to 5, further comprising prior to using the processor to segment the textual depiction, binarizing and then blurring the game data region according to game-customized binarization parameters and game-customized blurring parameters, respectively.

7. The method of any one of claims 1 to 6, further comprising after segmenting the textual depiction, using the processor to determine alphanumeric characters corresponding to the textual depiction.

8. The method of claim 7, wherein using the processor to determine alphanumeric characters corresponding to the textual depiction comprises comparing the textual depiction to game-customized font characters.

9. The method of any one of claims 1 to 8, further comprising after determining the alphanumeric characters, using the processor to process the alphanumeric characters using a regular expression to identify particular user statistics.

10. The method of any one of claims 1 to 9, wherein using the processor to obtain the screenshot comprises obtaining the screenshot from an additional processor networked to the processor, wherein the additional processor retrieves and queues a collection of screenshots of which the screenshot is one for batch transmission to the processor.

11. A system comprising:
a processor;
a communications interface communicatively coupled to the processor; and
a non-transitory computer readable medium communicatively coupled to the processor, wherein the medium has stored thereon computer program code that is executable by the processor and that, when executed by the processor, causes the processor to perform the method of any one of claims 1 to 10.

12. A non-transitory computer readable medium having stored thereon computer program code executable by processor and that, when executed by the processor, causes the processor to perform the method of any one of claims 1 to 10.
